(19) United States
(12) Patent Application Publication
(10) Pub. No.: US 2002/0174772 A1
(43) Pub. Date: Nov. 28, 2002

(54) Filter cassette and injection-molding tool for manufacturing the filter cassette frame

(76) Inventor: Adam Eberle, Linnenbach (DE)

Correspondence Address: KENYON & KENYON, ONE BROADWAY, NEW YORK, NY, 10004, US

(21) Appl. No.: 10/151,659

(22) Filed: May 20, 2002

(30) Foreign Application Priority Data
May 22, 2001 (DE) 101 24 846.6

(51) Int. Cl. B01D 53/02; B29C 45/14

(52) U.S. Cl. 96/134; 425/129.1

(57) ABSTRACT

An injection molding die for manufacturing a plastic frame on filter cassettes using edge-side plastic extrusion coating of the longitudinal sides of a zigzag-shaped, folded filter material, the die halves of the injection molding die being configured so as to engage each other in a tooth-like manner and forming a receiving space for the filter material and a molding space for the plastic frame, which are separated from each other by a clamping area formed by one of the tool teeth, in the clamping area (31) of the longitudinal sides (4) of the injection molding die (30), the gap dimension (7, 17) between the closed mold halves (1, 2) of the injection molding die (30) in the curved area (32) of the upper and/or lower fold flanks (9, 10) of the filter material (3) being smaller or greater than the gap dimension (8) of the fold flanks (11).

### BACKGROUND OF THE INVENTION

1. Field of the Invention

The invention relates to filter systems in which filter cassettes are interchangeably inserted into the prescribed opening.

2. Description of Related Art

Filter cassettes are used in vehicles in the airflow channel, to purify the air flowing into the interior of the vehicle. Usually, filter cassettes are made of a filter material that is folded in a zigzag configuration and is surrounded by a plastic frame. For manufacturing the plastic frame, the filter material is placed into an injection-molding tool and the plastic is injected in the corresponding molding space.

The injection molding tools are composed of two tool halves, that slide in an interlocking manner, between which are clamped the edges of the filter material. This is necessary to prevent the penetration of plastic into the receptacle space of the tool in response to the injection of the plastic into the molding space. However, this takes form with particular difficulty if the filter material contains an adsorbing layer, for example, made of active carbon granulates. The surface pressure present at the edges of the filter exerted by the injection molding tool is not uniform, and the danger exists that plastic will penetrate from the molding space into the receiving space of the filter. This is especially so at locations in which damage has arisen in the filter material during the preceding folding process.

While it is possible to achieve a roughly uniform specific surface pressure at the transverse sides of the filter as a result of an appropriate selection of the gap dimension between the mold halves of the injection molding tool with respect to the filter thickness, this is not provided at the longitudinal sides of the filter material. As a result of the folding of the filter material, which is at first planar, there arise in the area of the folded edges tensile stresses, which at these locations can lead to plastic deformation and, in some cases, to a tearing of the filter material. This happens especially in the case of a filter material that has a powerful adsorption layer.

The injection molding tools heretofore known for an edge-side extrusion coat of a zigzag-shaped, folded filter material are made up of two mold halves, the mold halves being configured so as to engage each other in a tooth-like manner according to the form of the filter material and bordering a receiving space for the filter material as well as a molding space for accommodating the longitudinal sides of the filter material and for shaping the plastic to be injected around the edge of the longitudinal sides. The upper and lower mold halves possess boundary limiting walls, so that the mold halves can be placed at a defined distance from each other. The filter material is gripped in the gap that forms in the clamping area between the form halves of the injection molding tool. In this context, the gap has a size that is smaller than the thickness of the filter material, so that the filter material is slightly pressed together and is gripped between the mold halves. In some filter materials, especially adsorbent filter material, there nevertheless exists the danger that the thickness of the material in the area of the folded edges is significantly less than in other areas due to the plastic deformation or the tearing of the material layer during the folding process. Here liquid plastic during the injection process can penetrate into the receiving space and therefore onto the filter surface of the filter material.

From German Patent 197 45 919 C1, an injection molding tool has become known which is suited for manufacturing the plastic frame for filter cassettes. In this context, as the filter material a material is used that has particles for adsorption or absorption of solid and/or gaseous constituents of a fluid. To prevent the penetration of plastic material from the molding space into the receiving space of the filter during the injection process, a transition space is provided on the transverse sides of the filter in the area between the molding space and the receiving space, the end of the folds of the filter being furnished with narrowed areas and expanded areas in the transition space, so that a type of labyrinth seal arises and the two mold halves of the injection molding tool are able to contact the filter material at only a slight application pressure. Using this injection molding tool, a satisfactory seal can be attained, although at the expense of higher manufacturing costs for the tool. In addition, at the edges of the filter, a filter surface is provided which is required for the formation of the labyrinth seal. As a result, given a prescribed size of the filter cassettes, filter space is also given up.

### SUMMARY OF THE INVENTION

It is an object of the invention to provide an injection molding tool, using which overinjection is avoided, and a filter cassette can be manufactured in which there is a reliable separation between the receiving space for the filter material and the molding space for the plastic frame.

According to the invention, in an injection molding tool for manufacturing a plastic frame on a filter cassette through an edge-side plastic extrusion coating of the longitudinal sides of a zigzag-shaped filter material, the tool halves of the injection molding tool being configured so as to engage each other in a tooth-like manner and constituting a receiving space for the filter material and a molding space for the plastic frame, which are separated from each other by a clamping area formed by one of the tool teeth, the above objective is achieved in that in the clamping area of the longitudinal sides of the injection molding tool, the gap dimension between the closed mold halves of the injection molding tool in the curved area of the upper and/or lower fold flanks of the filter material is smaller or larger than the gap dimension of the fold flanks. As a result of this measure, in all of the areas of the longitudinal sides of the filter material, a surface pressure of roughly equivalent magnitude is achieved, irrespective of the thickness of the filter material. Particularly suited is an injection molding tool of this type in manufacturing filter cassettes having filter materials that have an adsorbing layer, for example, made of active carbon granulates. Any damage occurring to the filter material during the folding process can now no longer lead to undesirable overinjections.

### BRIEF DESCRIPTION OF THE DRAWINGS

The invention will be described in greater detail with reference to the following drawings wherein:

FIG. 1 in the form of an extract depicts the side view of an injection molding tool having filter material inserted in the clamping area.

FIG. 2 depicts a cutaway portion according to line A-A in FIG. 1.

### DETAILED DESCRIPTION OF THE INVENTION

Tests have shown that filter cassettes manufactured in accordance with the invention have excellent working properties. The durability of the filter material in the plastic frame is uniformly good along the entire longitudinal side, because the filter material along the entire longitudinal side has an essentially uniform thickness and, as a result, is uniformly surrounded by the plastic frame.

The smaller gap dimension can be achieved by flattening the valley bottoms on one or both mold halves of the injection molding tool. As a result of a profiling of this type, it is also possible to achieve a stronger pressing in the area of the fold flanks.

The larger gap dimension can be achieved by flattening the tips of the teeth on one or both mold halves.

The filter cassette manufactured using an injection molding tool of this type is characterized by the fact that the thickness of the filter material in the curved area of the upper and/or lower fold flanks on the longitudinal sides of the plastic frame is smaller or greater than the thickness of the fold flanks. This is especially favorable when the filter material has at least one layer made of an adsorbent material.

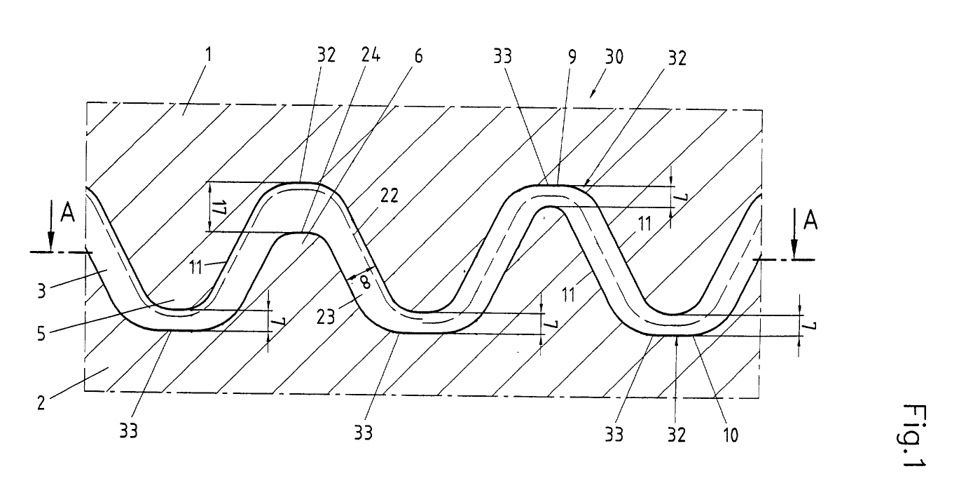

In FIG. 1, the concept according to the present invention is systematically depicted on the basis of a segment of an injection molding tool 30 in clamping area 31. No attempt is made to represent the entire injection molding tool, because the latter is widely known and can have various configurations. FIG. 1 therefore shows upper mold half 1 and lower mold half 2 of a segment of an injection molding tool 30 in a cutaway view prepared for the injection molding process, in which filter material 3 is gripped and pressed together at its longitudinal sides 4 by teeth 5 and 6 of injection molding tool 30. Gap dimension 7 in curved area 39 of upper and lower fold flanks 9 and 10 on the right side of the Figure is smaller than gap dimension 8 of fold flanks 11. The size of the curved areas on upper or lower fold edge 9 or 10 is selected as a function of inserted filter material 3. It is dimensioned so that it covers possible damage or changes at fold flanks 9, 10 and, as a result, leads to roughly the same specific surface pressure at fold flanks 9, 10, as exists at fold flanks 11. This way of reducing gap dimension 7 in curved area 32 in comparison to gap dimension 8 at fold flanks 11 is advantageous when a filter material is used that is symmetrical in its layer design. For example, a non-woven fabric layer in the middle, which is covered on both sides by particle layers. Valley bottoms 33 are flattened out on both mold halves 1 and 2 in curved area 32. In manufacturing the plastic frame for an asymmetrically configured filter material 3, which is made up, for example, of a nonwoven fabric layer 22 having a particle layer 23 applied thereon, a different configuration of the gap dimension is advantageous. This is depicted on the left side of FIG. 1. On the side of filter material 3 having particle layer 23, valley bottoms 33, as was described above, are flattened out, so that a smaller gap dimension 7 is present. In addition, tips of teeth 24 also on the side of particle layer 23 can additionally be flattened off, so that here a greater gap dimension 17 is achieved than gap dimension 8 of fold flanks 11.

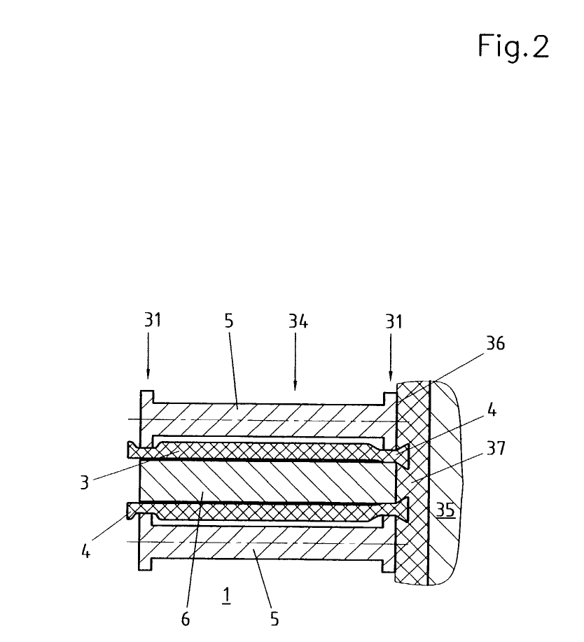

In FIG. 2, a cutaway view along line A-A in FIG. 1 is shown. Here the position of individual tool teeth 5 and 6 with respect to each other is visible. In this context, tool teeth 6 have a smooth continuous surface, whereas tool teeth 5 in the area of receiving space 34 have reduced edges, so that filter material 3 is not pressed between the teeth. Filter material 3 is only gripped in clamping areas 31 at its longitudinal sides 4. Between exterior wall 35 and end faces 36 of tool teeth 5 and 6 is molding space 37, in which the plastic is injected to form the plastic frame.

A filter cassette manufactured using an injection molding tool of this type is characterized by the fact that thickness 17 of filter material 3 in curved area 32 of upper and/or lower fold flanks 19 on longitudinal sides 4 of plastic frame 38 is smaller or greater than thickness 8 at fold flanks 11.

What is claimed is:

1. An injection molding tool for the manufacture of a plastic frame on filter cassettes using edge-side plastic extrusion coating of longitudinal sides of a filter material folded in a zig-zag shape, comprising: a pair of die halves which are configured so as to engage each other in a tooth-like manner and which form a receiving space for the filter material and a molding space for the plastic frame, which are separated from each other by a clamping area formed by the tool teeth, wherein, in a clamping area (31) of longitudinal sides (4) of the injection molding tool (30), there is a gap dimension (7) between the closed mold halves (1, 2) of the injection molding tool (30) in a curved area (32) of the upper or lower fold flanks (9, 10) of the filter material (3) which is smaller than the gap dimension (8) of the fold flanks (11) and a gap dimension (17) which is greater than the gap dimension (8) of the fold flanks (11).

2. The injection molding tool according to claim 1, wherein the smaller gap dimension (7) is produced by flattening off valley bottoms (33) on one of the mold halves (1, 2).

3. The injection molding tool according to claim 1, wherein the greater gap dimension (17) is produced by flattening off tips of the teeth (24) on one or both mold halves (1, 2).

4. The injection molding tool according to claim 2, wherein the greater gap dimension (17) is produced by flattening off tips of the teeth (24) on one or both mold halves (1, 2).

5. A filter cassette for filtering fluids, comprising: a filter material folded in a zig-zag shape and a plastic frame enclosing at least longitudinal sides of the filter material and manufactured in an injection molding tool, wherein the filter material (3) in a curved area (32) of upper or lower fold flanks (9, 10) on the longitudinal sides (4) of the plastic frame (38) has a thickness (7, 17) which is smaller and greater than the thickness (8) of the fold flanks (11).

6. The filter cassette according to claim 5, wherein the filter material (3) is made of a nonwoven fabric layer and at least one layer made of adsorptive particles.

7. The filter cassette according to claim 5, wherein the filter material (3) is configured asymmetrically in a layer construction.

8. The filter cassette according to claim 6, wherein the filter material (3) is configured asymmetrically in a layer construction.

9. The filter cassette according to claim 5, wherein the filter material (3) is made of a nonwoven fabric layer (22) and a particle layer (23) that is joined thereto.

10. The filter cassette according to claim 6, wherein the filter material (3) is made of a nonwoven fabric layer (22) and a particle layer (23) that is joined thereto.

11. The filter cassette according to claim 7, wherein the filter material (3) is made of a nonwoven fabric layer (22) and a particle layer (23) that is joined thereto.

12. The filter cassette according to claim 9, wherein on a side of the particle layer (23), valley bottoms (33) of the filter material (3) are flattened off, so that the thickness (7) of the filter material (3) is smaller than the thickness (8) of the fold flanks (11), or fold tips (24) of the filter material (3) are flattened off, so that the thickness (17) of the filter material (3) is greater than the thickness (8) of the fold flanks (11).

13. The filter cassette according to claim 10, wherein on a side of the particle layer (23), valley bottoms (33) of the filter material (3) are flattened off, so that the thickness (7) of the filter material (3) is smaller than the thickness (8) of the fold flanks (11), or fold tips (24) of the filter material (3) are flattened off, so that the thickness (17) of the filter material (3) is greater than the thickness (8) of the fold flanks (11).

14. The filter cassette according to claim 11, wherein on a side of the particle layer (23), valley bottoms (33) of the filter material (3) are flattened off, so that the thickness (7) of the filter material (3) is smaller than the thickness (8) of the fold flanks (11), or fold tips (24) of the filter material (3) are flattened off, so that the thickness (17) of the filter material (3) is greater than the thickness (8) of the fold flanks (11).
